(19) United States
(12) Patent Application Publication
(10) Pub. No.: US 2007/0143996 A1
(43) Pub. Date: Jun. 28, 2007

(54) Cylinder block and method for manufacturing the same

(76) Inventor: Hirofumi Michioka, Toyota-shi (JP)

Correspondence Address: KENYON & KENYON LLP, 1500 K STREET N.W., SUITE 700, WASHINGTON, DC, 20005, US

(21) Appl. No.: 11/709,235

(22) Filed: Feb. 22, 2007

Related U.S. Application Data
(62) Division of application No. 11/105,407, filed on Apr. 14, 2005.

(30) Foreign Application Priority Data
Apr. 21, 2004 (JP) 2004-125924

(51) Int. Cl. B23P 11/00; F02F 1/00

(52) U.S. Cl. 29/888.06; 123/193.2

(57) ABSTRACT

A cylinder block has a metal film on an inner circumferential surface of each cylinder. The film is constituted by a first sprayed layer formed on the inner circumferential surface of the cylinder and a second sprayed layer formed on the inner circumferential surface of the first sprayed layer. The hardness of the second sprayed layer is lower than the hardness of the first sprayed layer. It is preferred that the second sprayed layer have a Vickers hardness of 50 to 200. It is preferred that the first sprayed layer have a Vickers hardness of not less than 350. It is preferred that the first sprayed layer have a thickness of 400 μm to 500 μm. A method of manufacturing a cylinder block includes the step of casting a cylinder block, which involves casting the cylinder in the cylinder block, the step of forming the first sprayed layer on the inner circumferential surface of the cylinder, and the step of forming the second sprayed layer on the inner circumferential surface of the first sprayed layer.

### BACKGROUND OF THE INVENTION

The present invention relates to a cylinder block having a metal film on the inner circumferential surface of each cylinder and a method for manufacturing the cylinder block.

Since in a cylinder block each piston reciprocates within a cylinder, the inner circumferential surface of a cylinder is required to have wear resistance and seizure resistance. To meet these requirements, in conventional cylinder blocks, a metal film is formed on the inner circumferential surface of each cylinder.

For example, Japanese Laid-Open Patent Publication No. 3-90596 proposes a cylinder block that has, on the inner circumferential surface of each cylinder, a sprayed layer consisting of an aluminum film and a plating layer consisting of a silicon carbide film, which is formed on the surface of this sprayed layer. In this cylinder block, the wear resistance on the inner circumferential surface of each cylinder is increased by the above-described plating layer.

Since many fine pores are present on the surface of a sprayed layer, it is difficult to thoroughly remove foreign substances such as oil and water collecting on the surface of this sprayed layer even when the surface of the sprayed layer is subjected to cleaning treatment. Therefore, in the cylinder block of Japanese Laid-Open Patent Publication No. 3-90596, in which the plating layer is formed on the inner circumferential surface of the sprayed layer, the plating layer may fall off because the adhesion between the sprayed layer and the plating layer becomes insufficient due to the presence of foreign substances such as oil and water on the inner circumferential surface of the sprayed layer.

In the above-described cylinder block, the surface of the plating layer is worked after the formation of the sprayed layer and the plating layer. Since the surface of the plating layer must be worked to have a hardness level capable of withstanding wear with a piston, it is impossible to avoid a decrease in workability. In this case, since stresses within the cylinder become excessive due to working, the roundness of the cylinder bore decreases and this might bring about a decrease in dimensional accuracy.

### SUMMARY OF THE INVENTION

The present invention has been made in view of such circumstances as described above. The objective of the invention is to provide a cylinder block that ensures the wear resistance of cylinders and suppresses the exfoliation of a film, and improves the workability of the inner circumferential surface of each cylinder that comes into contact with a piston.

To achieve the above objective, in an aspect of the present invention, there is provided a cylinder block having a metal film on the inner circumferential surface of a cylinder. The film comprises a first sprayed layer formed on the inner circumferential surface of the cylinder and a second sprayed layer formed on the inner circumferential surface of the first sprayed layer. The hardness of the second sprayed layer is lower than the hardness of the first sprayed layer.

In another aspect of the present invention, there is provided a cylinder block which has a metal film on an inner circumferential surface of a cylinder, in which a piston reciprocates while contacting the film. In this cylinder block, the film comprises a plurality of sprayed layers. The sprayed layers include an outer sprayed layer with which the piston comes into contact. The hardness of the outer sprayed layer is the lowest of the sprayed layers.

In a further aspect of the present invention, there is provided a method for manufacturing a cylinder block which has a metal film on an inner circumferential surface of a cylinder. The film comprises a first sprayed layer formed on the inner circumferential surface of the cylinder and a second sprayed layer formed on the inner circumferential surface of the first sprayed layer. The hardness of the second sprayed layer is set at a value lower than the hardness of the first sprayed layer. This method comprises casting a cylinder block, which involves forming the cylinder in the cylinder block, forming the first sprayed layer on the inner circumferential surface of the cylinder, and forming the second sprayed layer on the inner circumferential surface of the first sprayed layer.

In an additional object of the present invention, there is provided a method of manufacturing a cylinder block which has a metal film on an inner circumferential surface of a cylinder. The film comprises a first sprayed layer formed on the inner circumferential surface of the cylinder and a second sprayed layer formed on the inner circumferential surface of the first sprayed layer. The hardness of the second sprayed layer is set at a value lower than the hardness of the first sprayed layer. This method comprises a first step of casting a cylinder block, which involves forming the cylinder in the cylinder block, a second step of boring an inner circumferential surface of the cylinder after the first step, a third step of cleaning the inner circumferential surface of the cylinder after the second step, a fourth step of forming the first sprayed layer on the inner circumferential surface of the cylinder after the third step, a fifth step of forming the second sprayed layer on the inner circumferential surface of the first sprayed layer after the fourth step, a sixth step of boring the inner circumferential surface of the second sprayed layer after the fifth step, and a step of honing the inner circumferential surface of the second sprayed layer after the sixth step.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view illustrating a cylinder block according to an embodiment of the present invention;

FIG. 2 is a plan view of the cylinder block;

FIG. 3 is a cross-sectional view taken along line 3-3 in FIG. 2;

FIG. 4 is an enlarged view showing encircled part C of FIG. 3;

FIG. 5A is a diagram that shows a first step in a method for manufacturing a cylinder block;

FIG. 5B is a diagram that shows a second step in the method for manufacturing a cylinder block;

FIG. 5C is a diagram that shows a third step in the method for manufacturing a cylinder block;

FIG. 5D is a diagram that shows a fourth step in the method for manufacturing a cylinder block;

FIG. 6A is a diagram that shows a fifth step in the method for manufacturing a cylinder block;

FIG. 6B is a diagram that shows a sixth step in the method for manufacturing a cylinder block;

FIG. 6C is a diagram that shows a seventh step in the method for manufacturing a cylinder block;

FIG. 6D is a diagram that shows an eighth step in the method for manufacturing a cylinder block;

FIG. 7 is an enlarged view of a conventional cylinder block.

### DETAILED DESCRIPTION OF THE PREFERRED EMBODIMENTS

A cylinder block 11 and a method of manufacturing the cylinder block according to one embodiment of the present invention will be described below with reference to the accompanying drawings.

The cylinder block 11 of this embodiment is applied to an in-line four-cylinder engine. This cylinder block 11 is formed of aluminum or an aluminum-based metal such as aluminum alloys.

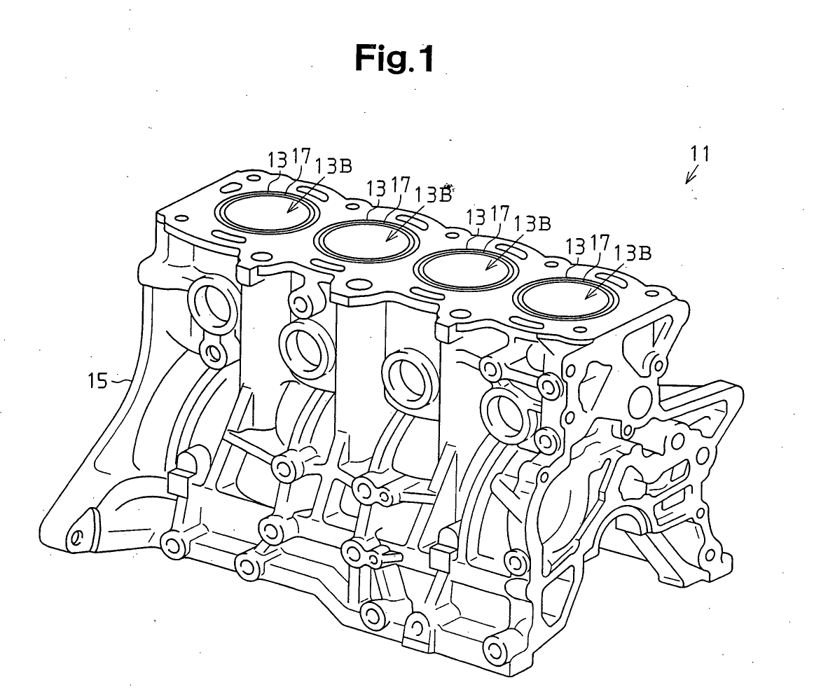

As shown in FIG. 1, the cylinder block 11 has cylinders 13 and one crankcase 15. The cylinder block 11 of this embodiment has a structure not provided with a cylinder liner in each cylinder 13, i.e., what is called a linerless type structure. A cylinder bore 13B to house a piston (not shown) is formed along the inner circumference of each cylinder 13. A metal film 17 is formed on the inner circumferential surface of each cylinder 13. In the cylinder block 11 made of an aluminum-based metal, each metal film 17 increases the wear resistance and impact resistance required of the cylinder 13.

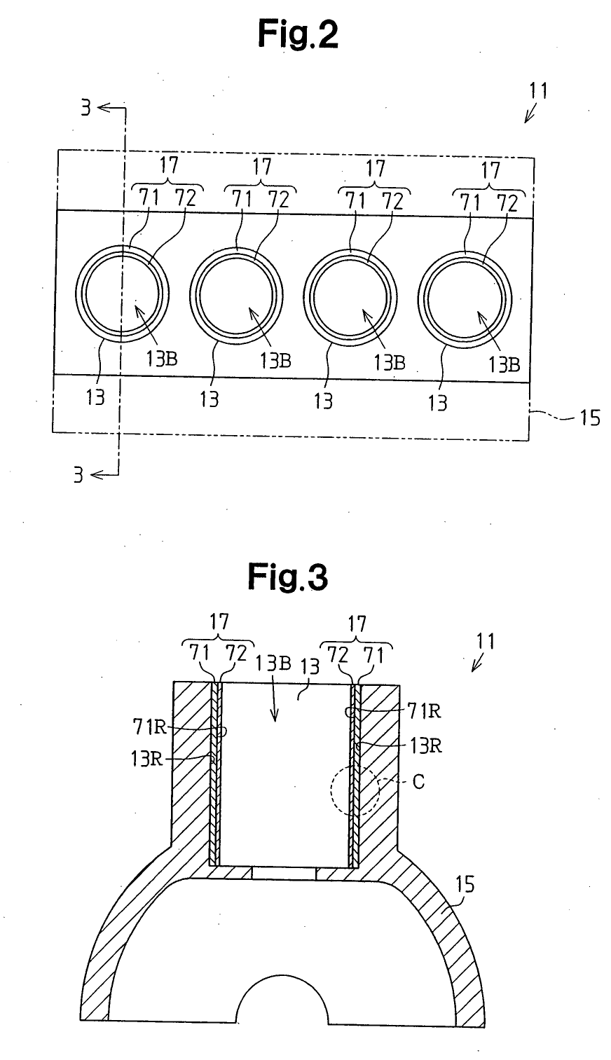

As shown in FIGS. 2 to 4, each film 17 is constituted by a first sprayed layer 71 formed on an inner circumferential surface 13R of the cylinder 13 and a second sprayed layer 72 formed on an inner circumferential surface 71R of this first sprayed layer 71. In each of the cylinders 13 shown in FIGS. 1 to 4, the cylinder bore 13B is defined by an inner circumferential surface 72R of the second sprayed layer 72. That is, in each cylinder 13, the inner circumferential surface 72R of the second sprayed layer 72 forms the inner circumferential surface on the side of the cylinder 13 that comes into contact with the piston. The inner circumferential surface 72R of the second sprayed layer 72 is referred to as the contact surface of the cylinder bore 13B.

Each of the first sprayed layers 71 is formed along the full circumference of the inner circumferential surface 13R of the cylinder 13. The first sprayed layer 71 is formed by thermally spraying any metal powder selected from, for example, an Fe—C alloy, an Fe—C—Cr alloy, an Fe—C—Cr—Si alloy, and an Fe—C—Mo alloy onto the inner circumferential surface 13R of the cylinder 13. The thickness T1 of each of the first sprayed layers 71 is set at 400 μm to 500 μm. The hardness H1 of each of the first sprayed layers 71 is set at a Vickers hardness of not less than 350.

Each of the second sprayed layers 72 is formed along the full circumference of the inner circumferential surface 71R of the first sprayed layers 71. The second sprayed layers 72 is formed by thermally spraying any metal powder selected from, for example, an Fe—C alloy, a Cu—Al alloy, and an Al—Sn alloy onto the inner circumferential surface 71R of the first sprayed layer 71. The hardness H2 of each of the second sprayed layers 72 is set at a Vickers hardness of 50 to 200.

The thickness and hardness of the first sprayed layers 71 and second sprayed layers 72 in the cylinder block 11 of this embodiment are shown in Table 1.

TABLE 1

| | Thickness (μm) | Vickers hardness |
|---|---|---|
| First sprayed layer | 400 ≦ T1 ≦ 500 | 350 ≦ H1 |
| Second sprayed layer | 0 < T2 | 50 ≦ H2 ≦ 200 |

In the cylinder block 11, the piston (piston ring) conforms to contact surface of the cylinder bore 13B by going through the following stages A to C when the piston reciprocates along the contact surface of the cylinder bore 13B during break-in period immediately after manufacture.

Stage A is an initial stage of break-in at which, when the piston reciprocates along the contact surface of the cylinder bore 13B immediately after manufacture, the piston begins to conform to the contact surface. At Stage A, the piston slides over the inner circumferential surface 72R of the second sprayed layer 72 because the contact surface of the cylinder bore 13B is formed by the inner circumferential surface 72R of the second sprayed layer 72. At this time, since the piston slides over the second sprayed layer 72 having a hardness suitable for break-in, the break-in of the piston with the second sprayed layer 72 proceeds well while the wear of the second sprayed layer 72 is being caused to proceed.

Stage B is the stage of break-in after the first sprayed layer 71 is partially exposed to the contact surface of the cylinder bore 13B. At Stage B, the piston slides over the contact surface of the cylinder bore 13B including both of the first and second sprayed layers 71, 72. On this contact surface of the cylinder bore 13B the piston comes into contact more easily with the second sprayed layers 72 than the first sprayed layers 71 and, therefore, the first sprayed layers 71 wears gently. The inner circumferential surface 71R of the first sprayed layer 71 is gradually made smooth through the wear of the cylinder bore 13B in which both the first and second sprayed layers 71, 72 are present.

Stage C is the stage at which the piston conforms to the contact surface while the piston sides over the contact surface of the cylinder bore 13B in which almost the entire second sprayed layer 72 has worn. The contact surface of the cylinder bore 13B at Stage C is formed by the inner circumferential surface 71R of the first sprayed layer 71 that has been made smooth.

When the piston has sufficiently conformed to the contact surface of the cylinder bore 13B in this manner, the surface roughness of the piston and the cylinder bore 13B at the contact surface decreases, and the piston and the cylinder bore 13B become smooth, with the result that a smooth reciprocation of the piston within the cylinder 13 becomes possible. Incidentally, there may sometimes be a case where even after the piston sufficiently conforms to the contact surface of the cylinder bore 13B, a contact surface of the cylinder bore 13B that includes both the first sprayed layer 71 and the second sprayed layer 72 is formed.

A method of manufacturing the cylinder block 11 will be described below.

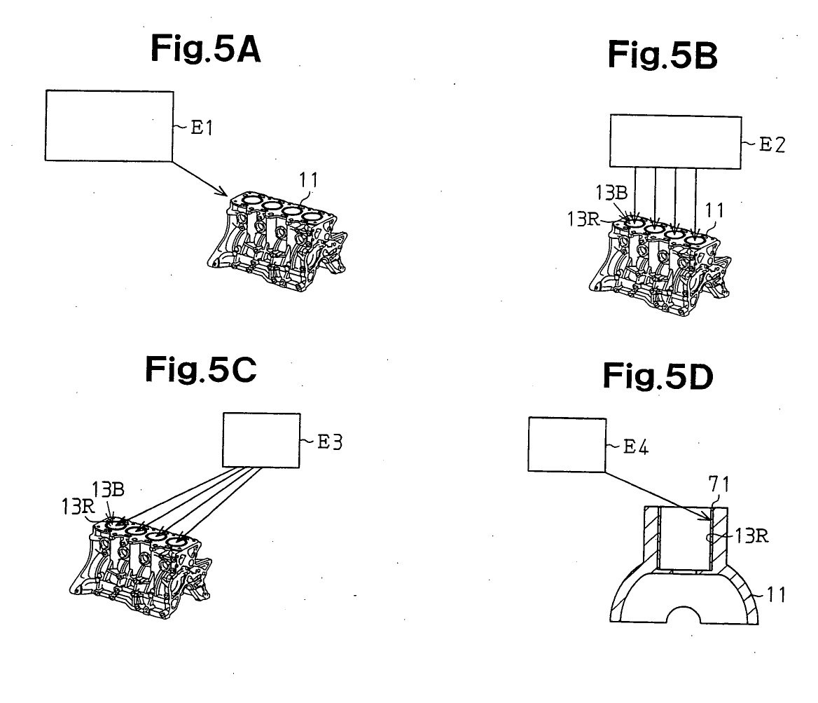

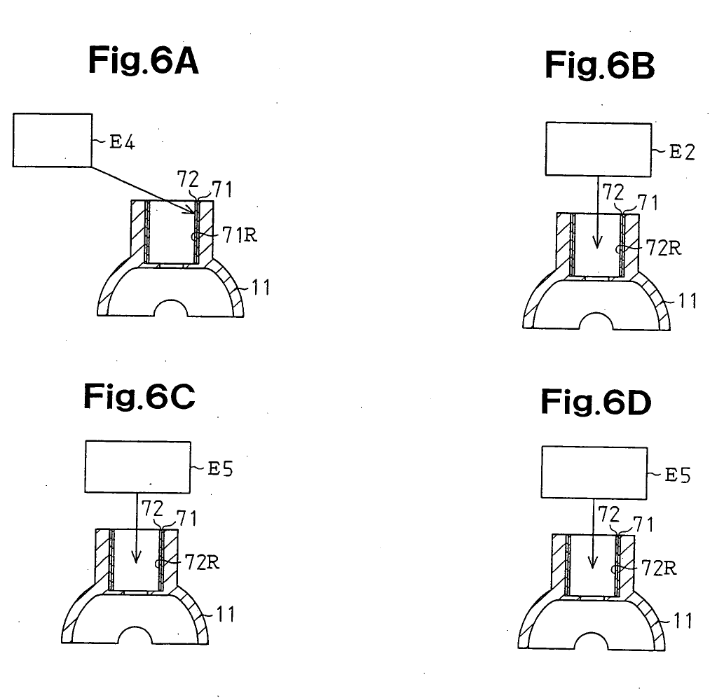

As shown in FIGS. 5A to 5D and FIGS. 6A to 6D, the cylinder block 11 is manufactured by carrying out the first step to the eighth step in this order.

In the first step, the cylinder block 11 is formed by use of a die casting machine E1. The cylinder block 11 having the cylinders 13 is formed by feeding a molten aluminum-based metal into a mold under pressure.

In the second step, the inner circumferential surface 13R of each of the cylinders 13 is bored by use of a boring machine E2. In the second step, the inner circumferential surface 13R of each of the cylinders 13 is bored with an accuracy required as rough working.

In the third step, the cleaning of the inner circumferential surface 13R of each of the cylinders 13 is performed by use of a water jet cleaning machine E3. Foreign substances such as oil and water on the inner circumferential surface 13R of each of the cylinders 13 are removed in the third step. As a result of this, the adhesion of the first sprayed layer 71 to the inner circumferential surface 13R of each of the cylinders 13 is increased. Because micro irregularities are formed on the inner circumferential surface 13R of each of the cylinders 13 due to the high-pressure water, the adhesion of the first sprayed layer 71 to the inner circumferential surface 13R of each of the cylinders 13 is further increased.

In the fourth step, the first sprayed layer 71 is formed by use of a thermal spraying device E4 on the inner circumferential surface 13R of each of the cylinders 13. In the fourth step, a metal powder for the first sprayed layer 71 formed from, for example, an Fe—C alloy, an Fe—C—Cr alloy, an Fe—C—Cr—Si alloy, and an Fe—C—Mo alloy is sprayed from the thermal spraying device E4 at the inner circumferential surface 13R of each of the cylinders 13. As a result of this, the first sprayed layer 71 is formed on the inner circumferential surface 13R of each of the cylinders 13.

After the completion of the fourth step, the metal powder for the first sprayed layer 71 set in the thermal spraying device E4 is replaced with a metal powder for the second sprayed layer 72 formed from an Fe—C alloy, a Cu—Al alloy or an Al—Sn alloy and the fifth step is carried out after that.

In the fifth step, the second sprayed layer 72 is formed on the inner circumferential surface 71R of the first sprayed layer 71 by use of the thermal spraying device E4. In the fifth step, the metal powder for the second sprayed layer 72 is sprayed from the thermal spraying device E4 at the inner circumferential surface 13R of each of the cylinders 13. As a result of this, the second sprayed layer 72 is formed on the inner circumferential surface 71R of the first sprayed layer 71. The fifth step is carried out in the same environment as with the fourth step.

In the sixth step, the contact surface of each of the cylinder bores 13B (the inner circumferential surface 72R of the second sprayed layer 72) is bored by use of the boring machine E2. In the sixth step, the contact surface of each of the cylinder bores 13B is bored with an accuracy required as finish working.

In the seventh step, the contact surface of each of the cylinder bores 13B (the inner circumferential surface 72R of the second sprayed layer 72) is honed by use of a honing machine E5. In the seventh step, the contact surface of each of the cylinder bores 13B is honed with an accuracy as rough working.

In the eighth step, the contact surface of each of the cylinder bores 13B (the inner circumferential surface 72R of the second sprayed layer 72) is honed by use of the honing machine E5. In the eighth step, the contact surface of each of the cylinder bores 13B is honed with an accuracy as finish working. As a result of the seventh step and the eighth step, fine grooves (crosshatching) are formed in the inner circumferential surface 72R of the second sprayed layer 72.

The thickness T1 of the first sprayed layer 71 and the thickness T2 of the second sprayed layer 72 after each of the above-described steps are shown in Table 2. Incidentally, the values shown here are an example and the thickness T1 of the first sprayed layer 71 and the thickness T2 of the second sprayed layer 72 may be appropriately changed according to manufacturing conditions.

TABLE 2

| | Thickness T1 of | Thickness T2 of |
|---|---|---|
| | first sprayed layer 71 | second sprayed layer 72 |
| First step | — | — |
| Second step | — | — |
| Third step | — | — |
| Fourth step | 400 μm | — |
| Fifth step | 400 μm | 300 μm |
| Sixth step | 400 μm | 100 μm |
| Seventh step | 400 μm | 50 μm |
| Eighth step | 400 μm | 30 μm |

In this embodiment, the initial thickness of the second sprayed layer 72 (the thickness T2 of the second sprayed layer 72 after the fifth step) is set at 300 μm. This initial thickness may be appropriately changed in the range of 100 μm to 500 μm according to boring and honing conditions.

Also, in this embodiment, the finish thickness of the second sprayed layer 72 (the thickness T2 of the second sprayed layer 72 after the eighth step) is set at 30 μm. This finish thickness may be appropriately changed in a range that enables the second sprayed layer 72 to be present on the contact surface of the cylinder bore 13B until each piston sufficiently conforms to the contact surface of the cylinder bore 13B. That is, the finish thickness of the second sprayed layer 72 is set at a value larger than zero.

According to a cylinder block and a method of manufacturing the cylinder block in this embodiment, the following advantages are obtained.

(1) In the cylinder block 11 of this embodiment, the film 17 is formed by the first sprayed layer 71 and the second sprayed layer 72 and the hardness of the second sprayed layer 72 is lower than the hardness of the first sprayed layer 71. When the second sprayed layer 72 is formed on the inner circumferential surface of the first sprayed layer 71, the formation of the second sprayed layer 72 is performed in the same environment as with the formation of the first sprayed layer 71 and, therefore, the adhering of foreign substances such as oil and water to the inner circumferential surface 71R of the first sprayed layer 71 is suppressed. Also, the formation of the two sprayed layers 71, 72 is performed at a high temperature and, therefore, even when foreign substances adhere to the inner circumferential surface 71R of the first sprayed layer 71, it is possible to remove much of such foreign substances with heat.

Since, as described above, the second sprayed layer 72 is formed on the inner circumferential surface 71R of the first sprayed layer 71 where little foreign substances exist, a decrease in the adhesion between the first sprayed layer 71 and the second sprayed layer 72 which is ascribable to these foreign substances is suppressed. As a result of this, the first sprayed layer 71 and the second sprayed layer 72 are bonded together with high adhesion and, therefore, it is possible to advantageously prevent the exfoliation of the second sprayed layer 72 from the first sprayed layer 71.

Incidentally, in the cylinder block described in Japanese Laid-Open Patent Publication No. 3-90596, in forming a plating layer on each sprayed layer, it is necessary to transfer the cylinder block to a production line for forming coating films. Therefore, it is impossible to avoid the adhering of foreign substances such as oil and water to the surfaces of the sprayed layers. For this reason, the adhesion between the sprayed layers and the plating layers decreased due to such foreign substances and the possibility of exfoliation of the plating layers was strong. In contrast, in a method of manufacturing the cylinder block 11 in this embodiment, the formation of the second sprayed layer 72 is performed only by the replacement work of the metal powder to be sprayed that is set in the thermal spraying device E4 after the formation of the first sprayed layer 71 and, therefore, it is possible to advantageously suppress the adhering of foreign substances to the inner circumferential surface 71R of the first sprayed layer 71.

Furthermore, since the hardness of the second sprayed layer 72 is lower than the hardness of the first sprayed layer 71, it is possible to increase the workability of the contact surface of the cylinder bore 13B (the inner circumferential surface 72R of the second sprayed layer 72). Incidentally, even when the second sprayed layer 72 wears as a result of the reciprocation of the piston, the contact surface of the cylinder bore 13B is formed by the first sprayed layer 71 having wear resistance suitable for the inner circumferential wall of the cylinder bore 13B. By adopting the above-described film structure at the contact surface of the cylinder bore 13B in this manner, it is possible to ensure the wear resistance of the cylinder 13, to suppress the exfoliation of the film 17 and to improve the workability of the contact surface of the cylinder bore 13B.

(2) When the second sprayed layer 72 has worn, the first sprayed layer 71 that is not honed comes into contact with the piston. However, since pores are present in the film 17 formed by thermal spraying, it is possible for the inner circumferential surface 71R of the first sprayed layer 71 to hold lubricating oil through such pores. As a result of this, even when the second sprayed layer 72 has worn, the piston and the contact surface of the cylinder bore 13B are advantageously lubricated. Since the honing of the first sprayed layer 71 is unnecessary in this manner, it is possible to suppress a decrease in workability during the formation of the film 17 by utilizing the characteristics of the two sprayed layers 71, 72.

(3) In the cylinder block 11 of this embodiment, the Vickers hardness of the second sprayed layer 72 is set in the range of 50 to 200. If the Vickers hardness of the second sprayed layer 72 is less than 50, there is a possibility that the second sprayed layer 72 may wear before the piston sufficiently conforms to the contact surface of the cylinder bore 13B, since the second sprayed layer 72 is too soft. If the Vickers hardness of the second sprayed layer 72 is higher than 200, workability during the honing of the second sprayed layer 72 worsens, since the second sprayed layer 72 is too hard. Furthermore, since stresses generated in the cylinder 13 increase during the honing of the second sprayed layer 72, there is also a possibility that dimensional accuracy such as the roundness and straightness of the cylinder bore 13B may worsen.

In this respect, since the above-described film structure is adopted in the cylinder block 11 of this embodiment, it is possible to ensure that the break-in of the piston with the contact surface of the cylinder bore 13B proceeds advantageously. Also, the workability of the contact surface of the cylinder bore 13B (the inner circumferential surface 72R of the second sprayed layer 72) is improved and it is possible to suppress the worsening of dimensional accuracy such as the roundness and straightness of the cylinder bore 13B.

(4) By setting the Vickers hardness of the second sprayed layer 72 at not more than 200, it is possible to ensure that the break-in of the piston with the contact surface of the cylinder bore 13B proceeds advantageously.

(5) In the cylinder block 11 of this embodiment, the Vickers hardness of the first sprayed layer 71 is set at not less than 350. If the Vickers hardness of the first sprayed layer 71 is less than 350, this may bring about the wear of the first sprayed layer 71 and seizure of the piston. In this respect, since the above-described film structure is adopted in the cylinder block 11 of this embodiment, it is possible to ensure smooth reciprocation of the piston through the first sprayed layer 71.

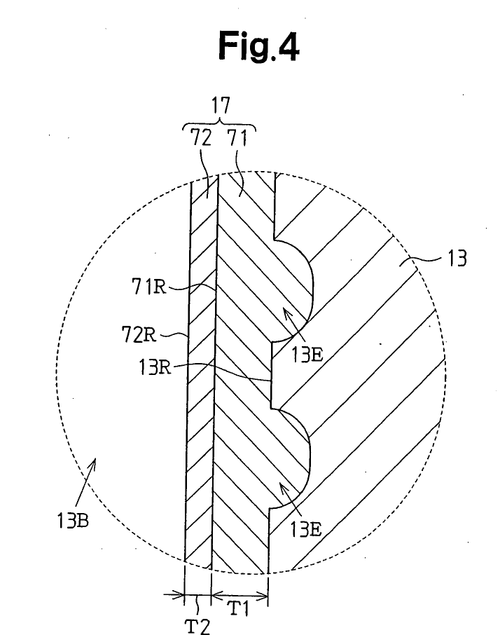

(6) In the cylinder block 11 of this embodiment, the thickness T1 of the first sprayed layer 71 is set in the range of 400 μm to 500 μm. If the thickness T1 of the first sprayed layer 71 is less than 400 μm, cavities 13E (see FIG. 4) formed in the inner circumferential surface 13R of the cylinder 13 are not thoroughly blocked by the first sprayed layer 71 and, therefore, there is a possibility that recesses may be formed in the inner circumferential surface 71R of the first sprayed layer 71 in positions corresponding to the cavities 13E. In this case, since there is a possibility that recesses are similarly formed also in the inner circumferential surface 72R of the second sprayed layer 72, it is difficult to make a smooth contact surface of the cylinder bore 13B where there is no recess ascribable to the cavities 13E. On the other hand, if the thickness T1 of the first sprayed layer 71 is larger than 500 μm, residual stresses generated due to the condensation of the film after spraying may become excessively large and, therefore, there is a possibility that cracks may be formed in the first sprayed layer 71. In this case, the bonding force of substances that constitute the first sprayed layer 71 decreases and this may cause the exfoliation of the first sprayed layer 71.

In this respect, since the above-described film structure is adopted in the cylinder block 11 of this embodiment, the cavities 13E formed in the inner circumferential surface 13R of the cylinder bore 13B are thoroughly blocked by the first sprayed layer 71. As a result of this, the contact surface of the cylinder bore 13B (the inner circumferential surface 72R of the second sprayed layer 72) is made smooth. Also, cracks become less apt to be formed in the interior of the first sprayed layer 71.

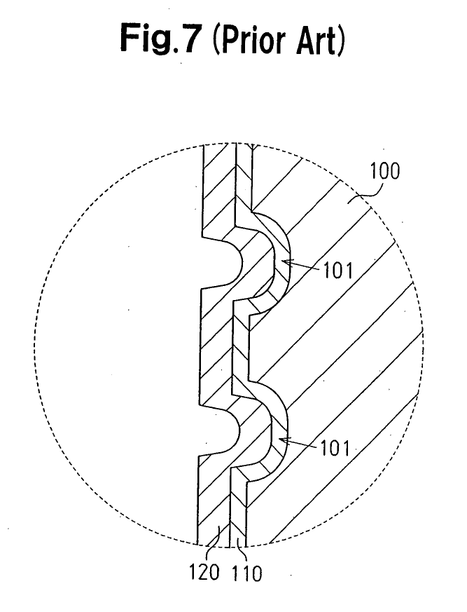

(7) In the cylinder block described in Japanese Laid-Open Patent Publication No. 3-90596, cavities in the inner circumferential surface of the cylinder are blocked and, therefore, a film formed by thermal spraying is provided on the inner circumferential surface. However, since the thickness of the film is set at less than 400 μm, the cavities cannot be thoroughly blocked. In this case, the film formed on the inner circumferential surface of the cylinder has the structure shown in FIG. 7. FIG. 7 is an enlarged cross-sectional view of a conventional cylinder block corresponding to the C part of FIG. 3.

As shown in FIG. 7, in a conventional cylinder block, cavities 101 formed in the inner circumferential surface of a cylinder 100 are not thoroughly clogged by a film 110. For this reason, recesses are present on the surface of a plating layer 120 formed on the inner circumferential surface of the film 110 and a smooth contact surface of the cylinder bore (the inner circumferential surface of the plating layer 120) is not formed. In contrast, in the film structure of the cylinder block 11 of this embodiment, as shown in FIG. 4, the cavities 13E present in the inner circumferential surface 13R of the cylinder 13 are blocked by the first sprayed layer 71 and, therefore, a smooth contact surface of the cylinder bore 13B (the inner circumferential surface 72R of the second sprayed layer 72) is formed.

(8) There is also known, for example, a cylinder block which has a film formed by thermal spraying on the inner circumferential surface of each cylinder and a plating layer which is formed on the inner circumferential surface of this film and consists of a soft material including tin plating. In such a cylinder block, the inner circumferential surface of the film is coated with the above-described material in order to promote that break-in of the piston with the film.

However, since in this cylinder block a plating layer including plating is formed on the inner circumferential surface of the sprayed layer, sufficient adhesion between the sprayed layer and the plating layer cannot be obtained owing to foreign substances such as oil and water adhering to the surface of the sprayed layer. For this reason, the exfoliation of the plating layer becomes apt to occur and this may cause seizure of the piston. Also, in the above-described cylinder, since the plating layer is formed by a very soft material, there is a strong possibility that the plating layer may wear before the piston sufficiently conforms to the contact surface of the cylinder bore.

In order to ensure that the piston conforms better to the contact surface of the cylinder bore, basically it is preferred that the film of the contact surface of the cylinder bore be formed from a soft material. However, if the above-described film is formed from an excessively soft material, there is a strong possibility that due to the wear of the film as described above, the piston may conform insufficiently to the contact surface. In this respect, in the cylinder block 11 of this embodiment the second sprayed layer 72 is formed on the inner circumferential surface 71R of the first sprayed layer 71 and the Vickers hardness of the second sprayed layer 72 is set at 50 to 200, whereby the exfoliation of the second sprayed layer 72 is suppressed and the piston is caused to conform to the contact surface of the cylinder bore 13B.

(9) In a method of manufacturing the cylinder block 11 of this embodiment, the initial thickness of the second sprayed layer 72 (the thickness T2 of the second sprayed layer 72 after the fifth step) is set in the range of 100 μm to 500 μm. If the initial thickness is smaller than 100 μm, it becomes difficult to leave a sufficient working allowance for boring and honing. If the initial thickness is larger than 500 μm, residual stresses generated due to the condensation of the film after thermal spraying become excessively large and, therefore, cracks may be formed in the interior of the second sprayed layer 72. In this case, the bonding force of substances that constitute the second sprayed layer 72 decreases and this may cause the exfoliation of the second sprayed layer 72. In this respect, in a manufacturing method of this embodiment, the boring and honing of the second sprayed layer 72 are advantageously carried out. Also, it is possible to suppress the formation of cracks in the interior of second sprayed layer 72.

<Modifications>

It should be apparent to those skilled in the art that the present invention may be embodied in many other specific forms without departing from the spirit or scope of the invention. Particularly, it should be understood that the invention may be embodied in the following forms.

In the first step, the cylinder block 11 may be formed by a casting process other than die casting.

In the third step, the cleaning of the inner circumferential surface 13R of the cylinder 13 may be performed by a cleaning method other than water jet cleaning.

In the fourth step and the fifth step, it is also possible to use a different thermal spraying device.

In order to ensure more preferred wear resistance, it is also possible to set the Vickers hardness of the first sprayed layer 71 at not less than 400.

The material for the first and second sprayed layers 71, 72 is not limited to the enumerated metals, but other appropriate metals may be adopted.

Each film 17 may be constituted by three or more sprayed layers. In this case, the hardness of the outer sprayed layer with which the piston comes into contact, i.e., the sprayed layer that forms the contact surface of the cylinder bore 13B, is set at a value smaller than the hardness of any other sprayed layers. Even when such a structure is adopted, a decrease in the adhesion between the sprayed layers constituting the metal film 17 is suppressed in the same manner as with the above-described embodiment. As a result of this, the sprayed layers are bonded together with high adhesion and, therefore, it is possible to suppress the exfoliation of the sprayed layer (film 17).

Also, since the hardness of the above-described outer sprayed layer is set at a value smaller than the hardness of any other sprayed layers, it is possible to improve the workability of the contact surface of the cylinder bore 13B. Incidentally, since the hardness of the above-described outer sprayed layer is set at a small value, even in a case where the outer sprayed layer has worn as a result of the reciprocation of the piston, the contact surface of the cylinder bore 13B is formed by other sprayed layers having wear resistance suitable for the inner circumferential wall of the cylinder bore 13B. Therefore, according to this modification, it is possible to provide a cylinder block 11 which ensures the wear resistance of the cylinder 13, suppresses the exfoliation of the film 17, and improves the workability of the contact surface of the cylinder bore 13B.

Incidentally, in this modification, for the same reason as in the case of the second sprayed layer 72 of the above-described embodiment, it is preferred that the Vickers hardness of the above-described outer sprayed layer be set at 50 to 200. Also, for the same reason as in the case of the first sprayed layer 71 of the above-described embodiment, it is preferred that the Vickers hardness of the inner sprayed layer formed on the inner circumferential surface 13R of the cylinder 13 be not less than 350. For the same reason as in the case of the first sprayed layer 71 of the above-described embodiment, it is preferred that the thickness of the above-described inner sprayed layer be set at 400 μm to 500 μm.

The present invention may be applied to any cylinder blocks which have a metal film on the inner circumferential surface of each cylinder in addition to the cylinder block of an in-line four-cylinder engine. Also, the material for the cylinder blocks is not limited to an aluminum-based metal.

Therefore, the present examples and embodiments are to be considered as illustrative and not restrictive and the invention is not to be limited to the details given herein, but may be modified within the scope and equivalence of the appended claims.

What is claimed is:

1. A method of manufacturing a cylinder block which has a metal film on an inner circumferential surface of a cylinder, the film comprising a first sprayed layer formed on the inner circumferential surface of the cylinder and a second sprayed layer formed on the inner circumferential surface of the first sprayed layer, and the hardness of the second sprayed layer being set at a value lower than the hardness of the first sprayed layer,
wherein the method comprises:
a step of casting a cylinder block, which involves casting the cylinder in the cylinder block;
a step of forming the first sprayed layer on the inner circumferential surface of the cylinder; and
a step of forming the second sprayed layer on the inner circumferential surface of the first sprayed layer.

2. A method of manufacturing a cylinder block which has a metal film on an inner circumferential surface of a cylinder, the film comprising a first sprayed layer formed on the inner circumferential surface of the cylinder and a second sprayed layer formed on the inner circumferential surface of the first sprayed layer, and the hardness of the second sprayed layer being set at a value lower than the hardness of the first sprayed layer,
wherein the method comprises:
a first step of casting a cylinder block, which involves casting the cylinder in the cylinder block;
a second step of boring an inner circumferential surface of the cylinder after the first step;
a third step of cleaning the inner circumferential surface of the cylinder after the second step;
a fourth step of forming the first sprayed layer on the inner circumferential surface of the cylinder after the third step;
a fifth step of forming the second sprayed layer on the inner circumferential surface of the first sprayed layer after the fourth step;
a sixth step of boring the inner circumferential surface of the second sprayed layer after the fifth step; and
a step of honing the inner circumferential surface of the second sprayed layer after the sixth step.

3. The method of manufacturing a cylinder block according to claim 2, wherein in the fifth step the second sprayed layer is formed in a thickness of 100 μm to 500 μm, inclusive.
